(19) United States
(12) Patent Application Publication
(10) Pub. No.: US 2005/0001366 A1
(43) Pub. Date: Jan. 6, 2005

(54) CONICAL RUBBER BEARING

(75) Inventor: Johan Hederstierna, Kungsbacka (SE)

Correspondence Address: TRACY W. DRUCE, ESQ., 1496 EVANS FARM DR, MCLEAN, VA, 22101, US

(73) Assignee: VOLVO LASTVAGNAR AB, Goteborg (SE)

(21) Appl. No.: 10/711,161

(22) Filed: Aug. 28, 2004

Related U.S. Application Data
(63) Continuation of application No. PCT/SE03/00180, filed on Feb. 2, 2003.

(30) Foreign Application Priority Data
Feb. 28, 2002 (SE) 0200617-9

(51) Int. Cl. F16F 1/30

(52) U.S. Cl. 267/141.1; 267/270; 267/7

(57) ABSTRACT

Method and arrangement for providing a bearing arrangement for mounting the spring suspension for a leaf-spring-supported bogie on a vehicle. The arrangement includes a bracket, a leaf-spring support and two bearing elements. The bearing elements have a number of parallel, conical, tubular supporting elements and at least one conical, tubular liner.

### CROSS-REFERENCE TO RELATED APPLICATIONS

The present application is a continuation patent application of International Application No. PCT/SE03/00180 filed 02 Feb. 2003 which was published in English pursuant to Article 21(2) of the Patent Cooperation Treaty, and which claims priority to Swedish Application No. 0200617-9 filed 28 Feb. 2002. Said applications are expressly incorporated herein by reference in their entireties.

### TECHNICAL FIELD

The present invention relates to a bearing arrangement for mounting the spring suspension for a leaf-spring-supported bogie on a vehicle and a method for mounting the spring suspension for a leaf-spring-supported bogie on a vehicle.

### BACKGROUND

Today, the spring suspension for a leaf-spring-supported bogie on a heavy-duty vehicle, for example a truck, is mounted by means of a sliding bearing. The sliding bearing consists of a round metal shaft which is mounted in a corresponding recess in a cradle. The bearing means consists of an annular element made of, for example, copper, plastic or a composite material which is lubricated with grease in order to reduce the friction and increase the life.

This bearing system has to have torsional rigidity which is as low as possible. The reason is that the axles on the bogie are to be capable of following the irregularities of the ground so that the load can be distributed uniformly between the two axles the whole time, and so that what is known as load-shifting is prevented. For a vehicle with drive on both axles, both wheel pairs must moreover have contact with the ground so that driving power is not lost. At the same time, other rigidities in the bearing system have to be as high as possible; the cardanic rigidity, for example, has to be as high as possible in order to prevent the springs of the vehicle striking against the frame sides on the vehicle. The bearings must moreover have sufficiently great strength in order to cope with the loads in different directions brought about by the axle load.

Although these sliding bearings have the desired bearing characteristics and therefore function in a technically satisfactory manner, they nevertheless have a number of disadvantages. A major disadvantage is their maintenance-intensive construction. A sliding bearing on, for example, a timber vehicle, which is subjected to great loads and a hard environment, may need to be lubricated every day, which is both costly and time-consuming. The construction also results in the life of the sliding bearing being relatively limited, even if it is lubricated according to the instructions. Negligence with lubrication leads to the bearings wearing out considerably faster.

As an example, GB 2098937 discloses a lubricatable sliding bearing for mounting a tandem axle on a vehicle.

Attempts are being made in the market to replace the sliding bearing with some type of cylindrical rubber bearing. This is being done primarily in order to provide a maintenance-free (that is to say, lubrication-free) bearing system. The greatest disadvantage of these bearings is torsional rigidity which is too high, and can cause the problems described above. Furthermore, the rigidity in other directions is dependent on the torsional rigidity; that is to say, high torsional rigidity leads to high rigidities in other directions. In a related way, reduced torsional rigidity leads to reduced rigidity in other directions, which can result in extra stiffening being required.

U.S. Pat. No. 2,810,587 and U.S. Pat. No. 3,099,459 disclose examples of cylindrical rubber bearings for mounting tandem axles on vehicles.

It would also be technically possible to use some form of roller bearing. However, such a solution is extremely expensive.

### DISCLOSURE OF THE INVENTION

An object of the presently disclosed invention is therefore to bring about mounting of the spring suspension for a leaf-spring-supported bogie which has low torsional rigidity, and moreover is maintenance-free. The invention also embodies a method for bringing about mounting of the spring suspension for a leaf-spring-supported bogie which has low torsional rigidity and is maintenance-free.

In at least one embodiment, the invention takes the form of a bearing arrangement for mounting the spring suspension for a leaf-spring-supported bogie on a vehicle. The arrangement comprises (includes, but is not necessarily limited to) a bracket, a leaf-spring support and two bearing elements. The above-stated object of the invention is achieved by virtue of the fact that the bearing elements include a number of parallel, conical, tubular supporting elements and at least one conical, tubular liner. In a complimentary manner, the associated method achieves this object by virtue of the fact that two conical springing elements are mounted between a bracket and a leaf-spring support, and that a clamping device is adjusted mechanically so that the springing elements are prestressed in the axial direction.

By means of this first embodiment of the inventive bearing arrangement, a bearing for mounting the spring suspension for a leaf-spring-supported bogie on a vehicle is obtained, which has low torsional rigidity at the same time as it is maintenance-free.

In an advantageous first development (version) of the system according to the invention, the bearing arrangement is prestressed. The purpose of this is to increase the strength and the torsional rigidity in the bearing arrangement.

In an advantageous second development of the bearing arrangement according to the invention, the outer and/or inner surface on the bearing elements is designed so that it is parallel to the central axis of the bearing arrangement in the axial direction. The purpose of this is to facilitate assembly in some applications.

A method according to the invention for mounting the spring suspension on a leaf-spring-supported bogie on a vehicle comprises the steps of (1) mounting two conical bearing elements between a bracket and a leaf-spring support; and (2) mechanically adjusting a clamping device so that the springing elements are prestressed in the axial direction.

The advantage of this method is that it provides a bearing which has low torsional rigidity, but high rigidities in other directions while at the same time being essentially maintenance-free.

### BRIEF DESCRIPTION OF FIGURES

The invention will be described in greater detail below with reference to illustrative embodiments shown in the accompanying drawings, and in which:

FIG. 1 is an exploded, perspective assembly view of a bearing arrangement configured according to the present invention;

FIG. 2 is an assembled perspective view of a bearing arrangement configured according to the present invention; and

FIG. 3 is a cross section view of a bearing element forming part of the bearing arrangement.

### DESCRIPTION OF ILLUSTRATIVE EMBODIMENTS

The illustrative embodiments of the invention described below with, in several developments (versions or enhancements), are to be regarded only as examples, and are in no way to be considered as limitations on the protective scope of the patent claims. In the illustrative embodiments described herein, the same reference numerals utilized in the various Figs. refer to the same (type) of component. Each component is therefore not described in detail with respect to all of the illustrative embodiments.

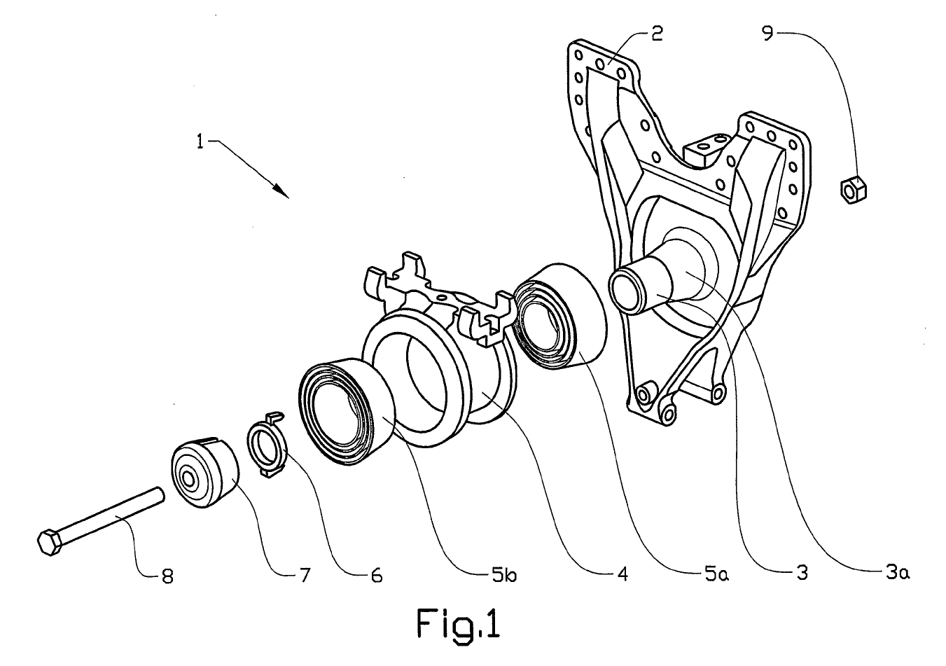

The bearing arrangement shown in FIG. 1 for mounting the spring suspension on a leaf-spring-supported bogie on a vehicle comprises a bracket 2, a leaf-spring support 4 and two bearing elements 5a, 5b. The bearing arrangement also comprises a rubber seal 6, a locking cone 7, a bolt 8 and a locking nut 9.

As background, a typical leaf-spring-supported bogie is constructed with a leaf spring that is centrally suspended and mounted in a bracket in the form of a bogie support. A leaf spring is constructed from a number of spring leaves, either as a conventional leaf spring or as a parabolic spring. A rear axle is mounted in a known manner at each of the two ends of the leaf spring. Such an arrangement is also referred to as a tandem axle. One or both of the rear axles can be driving.

The bracket 2, also referred to as a heart bracket, constitutes the central frame attachment for the bogie. It is fixed to the frame by bolted or riveted joints. It comprises a tubular neck element 3 with a conical portion 3a. The conical portion 3a is intended to interact with the bearing element 5a.

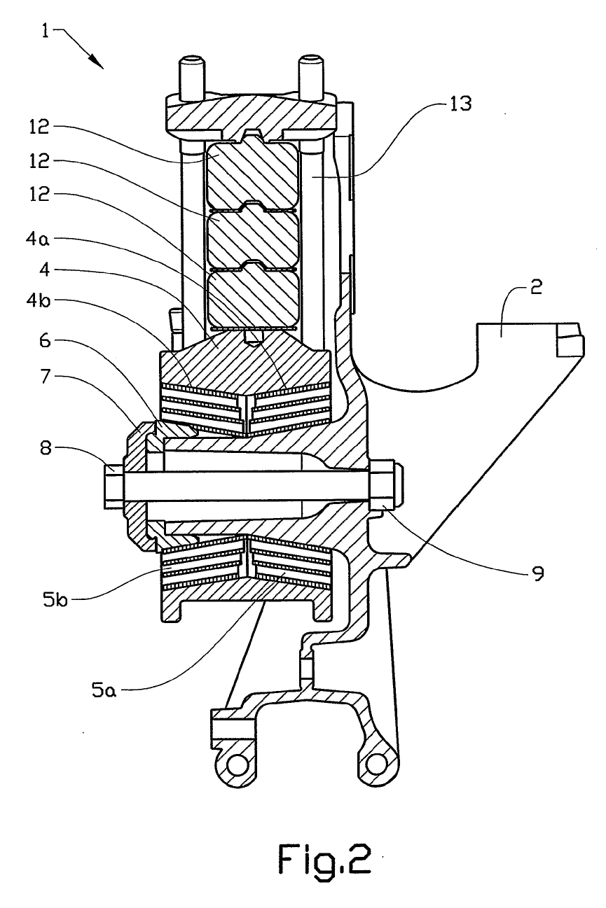

The leaf-spring support 4 constitutes the outer, movable part of the bearing arrangement. The leaf spring, consisting of a number of spring leaves 12, is fixed on the leaf-spring support 4 in a known manner, for example by clamps 13 (see FIG. 2). The inside of the leaf-spring support 4 comprises two conical surfaces 4a, 4b intended to interact with the outer surfaces of the bearing elements 5a, 5b.

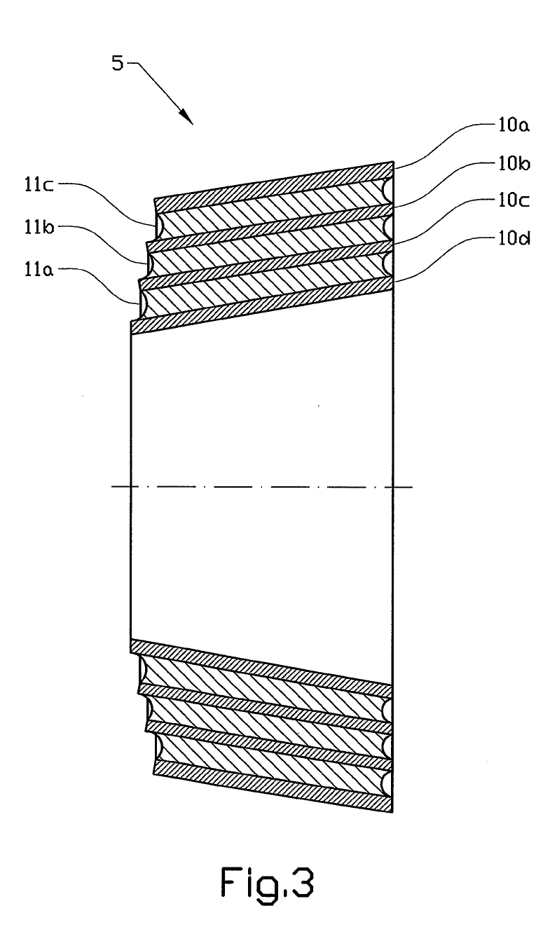

The bearing elements 5a, 5b consist of a number of conical, tubular supporting elements 10a-10d (see FIG. 3). These supporting elements are preferably made of metal, although it is possible to use a composite material. The supporting elements are advantageously positioned parallel to one another. Between the supporting elements, there is at least one conical, tubular liner 11a-11c. The liner is made of an elastic material, for example rubber or plastic. A bearing element 5 is advantageously made as a component, that is to say the supporting elements and the liners are firmly interconnected. This can be effected by, for example, vulcanization.

A bearing element 5 is advantageously made so that the innermost supporting element 10d is longer in the axial direction than the next supporting element 10c. The outermost supporting element 10a is shortest in the axial direction. The edge surfaces of the supporting elements advantageously lie in the same radial plane on the side where the diameter of the bearing element is smallest (compare FIG. 3) when the bearing element is unloaded.

When the bearing arrangement 1 is assembled, a first bearing element 5a is located on the conical portion 3a of the bracket 2. Then the conical surface 4a of the leaf-spring support is located against the bearing element 5a. A second bearing element 5b is located against the conical surface 4b of the leaf-spring support. The seal 6, the locking cone 7, the bolt 8 and the nut 9 are then mounted. The bearing arrangement is then prestressed by means of the bolt 8. When the bolt 8 is tightened, the locking cone 7 will be pressed in the direction toward the bracket 2. This results in the bearing elements 5a, 5b being deformed. The outer supporting element 10a of the bearing elements bears against the conical surfaces 4a, 4b of the leaf-spring support and therefore cannot move. The inner supporting element 10d of the bearing elements is movable in the axial direction, however, and will, when the bolt 8 is tightened, be displaced in the axial direction. The supporting element 10d in the bearing element 5a will be displaced in the direction toward the bracket 2, and the supporting element 10d in the bearing element 5b will at the same time be displaced in the opposite direction. This results in the edge surfaces of the supporting elements coming to lie in the same radial plane on the side where the diameter of the bearing element is greatest (compare FIG. 2) when the prestressing is complete; that is to say, when the bearing arrangement has been assembled.

The degree of prestressing is determined by the strength requirements and rigidity requirements for the bearing arrangement. Material selection, and the dimensioning of, above all, the liners, will also affect the rigidities of the bearing arrangement in the various directions, and thus also the magnitude of the prestressing.

By virtue of the fact that the bearing arrangement is made with conical bearing elements, the ultimate axial bearing resistance in the bearing arrangement is increased at the same time as the axial rigidity is high. The ultimate vertical bearing resistance increases at the same time as the strength of the bearing arrangement increases when the bearing arrangement is prestressed in the axial direction. The prestressing provides a precompression in the material of the liners. The desired freedom of movement in the bearing arrangement; that is to say, the lowest possible torsional rigidity in the radial direction, is achieved by selecting the number of liners and the material properties of the liners. For typical bogie springing, a torsional movement of roughly +/−10 degrees is desirable.

In the first illustrative embodiment, a bearing element 5 is made from four supporting elements 10a, 10b, 10c, 10d and three liners 11a, 11b, 11c. The dimensions of the component parts are selected so that they meet the requirements for strength and mechanical properties set for the complete bearing arrangement. This also applies for the properties of the rubber mixture of the liner.

In a development, it is possible to vary the number of supporting elements and liners in a bearing element. For example, it is possible to use three supporting elements and two liners. It is also possible to use five supporting elements and four liners. The number of supporting elements and liners is determined by the requirements for the bearing arrangement. Fewer supporting elements result in a bearing element which has higher torsional rigidity, more supporting elements and liners result in a bearing element with lower torsional rigidity but in which the rotational rigidity, for example, may also be lower.

In a second development, it is possible for the outer and/or inner surface on a bearing element also to consist of an elastic liner. This may be advantageous when, for example, the bracket and/or the leaf-spring support is/are suited to such an embodiment. The reason may be, for example, cost or easier assembly.

In a third development, the outer and/or inner surface on the bearing element is not conical, but parallel to the central axis of the bearing arrangement in the axial direction. This may be advantageous when the construction allows, for example in order to reduce the cost or to simplify assembly.

In a first illustrative embodiment of the method according to the invention, two conical bearing elements are mounted between a bracket and a leaf-spring support. A mechanical clamping device is then adjusted so that the bearing elements are prestressed in the axial direction. The advantage of this method is that mounting which has low torsional rigidity, high rigidity in other directions and great strength and is maintenance-free is obtained. The degree of prestressing is adapted to the requirements for the bearing arrangement.

The invention is not to be regarded as being limited to the illustrative embodiments described above, but a number of further variants and modifications are conceivable within the scope of the patent claims. For example, the bearing arrangement can also be used for other types of mounting when a bearing with high ultimate bearing resistance and low rigidity in the radial direction (that is to say, low torsional rigidity) is required.

1. A bearing arrangement (1) for mounting the spring suspension for a leaf-spring-supported bogie on a vehicle, said arrangement comprising:
a bracket (2), a leaf-spring support (4) and two bearing elements (5a, 5b); and
each of said bearing elements (5a, 5b) comprising a plurality of conical, coaxial tubular supporting elements (10a, 10b, 10c, 10d) and at least one conical, tubular liner (11a, 11b, 11c).

2. The bearing arrangement (1) as recited in claim 1, wherein said bearing elements (5a, 5b) are restrained between the leaf-spring support (4) and the bracket (2) with a pretensioning thereby induced in the bearing elements (5a, 5b) in an axial direction thereof.

3. The bearing arrangement (1) as recited in claim 1, wherein said supporting elements (10a, 10b, 10c, 10d) vary in length in the axial direction so that an innermost supporting element (10d) is longer than an outermost supporting element (10a).

4. The bearing arrangement (1) as recited in claim 1, wherein said supporting elements (10a, 10b, 10c, 10d) are firmly connected to the liners (11a, 11b, 11c).

5. The bearing arrangement (1) as recited in claim 1, wherein said outer conical, tubular bearing element (10a) is configured with an outer surface oriented parallel to a central axis of the bearing arrangement in the axial direction.

6. The bearing arrangement (1) as recited in claim 1, wherein said inner conical, tubular bearing element (10d) is configured with an inner surface oriented parallel to a central axis of the bearing arrangement in the axial direction.

7. The bearing arrangement (1) as recited in claim 1, wherein said conical, tubular supporting elements (10a, 10b, 10c, 10d) are made of metal.

8. The bearing arrangement (1) as recited in claim 1, wherein said conical, tubular supporting elements (10a, 10b, 10c, 10d) are made of a composite material.

9. The bearing arrangement (1) as recited in claim 1, wherein said at least one conical, tubular liner (11a, 11b, 11c) is made of a rubber material.

10. The bearing arrangement (1) as recited in claim 1, wherein said at least one conical, tubular liner (11a, 11b, 11c) is made of a plastic material.

11. The bearing arrangement (1) as recited in claim 1, wherein at least one of said bearing elements (5a; 5b) is constructed from four conical, tubular supporting elements (10a, 10b, 10c, 10d) and three conical, tubular liners (11a, 11b, 11c).

12. The bearing arrangement (1) as recited in claim 1, wherein at least one of said bearing elements (5a; 5b) is constructed from at least four conical, tubular supporting elements (10) and at least three conical, tubular liners (11).

13. A method for mounting a spring suspension of a leaf-spring-supported bogie to a vehicle, said method comprising:
providing a bearing arrangement comprising a bracket (2), a leaf-spring support (4) and two bearing elements (5a, 5b), and each of said bearing elements (5a, 5b) comprising a plurality of conical, coaxial tubular supporting elements (10a, 10b, 10c, 10d) and at least one conical, tubular liner (11a, 11b, 1c);
mounting said two conical bearing elements between said bracket and said leaf-spring support; and
mechanically adjusting a clamping device so that the bearing elements are prestressed in the axial direction.

14. A vehicle comprising:
two rear axles, two brackets (2) and two leaf springs, and wherein said rear axles are respectively mounted at two ends of the leaf springs; and
each of said leaf springs being mounted on said brackets (2) by a bearing arrangement comprising a bracket (2), a leaf-spring support (4) and two bearing elements (5a, 5b), and each of said bearing elements (5a, 5b) comprising a plurality of conical, coaxial tubular supporting elements (10a, 10b, 10c, 10d) and at least one conical, tubular liner (11a, 11b, 11c).
